(19) United States
(12) Patent Application Publication
(10) Pub. No.: US 2006/0031003 A1
(43) Pub. Date: Feb. 9, 2006

(54) Distributed Traffic Information System

(75) Inventors: QiLun Sun, Weston, FL (US); Yu Li, Weston, FL (US)

Correspondence Address: QILUN SUN, 1465 MIRA VISTA CIRCLE, WESTON, FL, 33327, US

(73) Assignees: QiLun Sun, Weston, FL (US); Yu Li, Weston, FL (US)

(21) Appl. No.: 11/161,391

(22) Filed: Aug. 2, 2005

Related U.S. Application Data
(63) Continuation of application No. 60/522,026, filed on Aug. 3, 2004.

(51) Int. Cl. G01C 21/34; G08G 1/00

(52) U.S. Cl. 701/117; 701/210; 340/995.13

(57) ABSTRACT

This invention discloses a method for collecting and propagating traffic information for optimizing traffic content. Single-vehicle-traffic-data is collected and broadcasted to vehicles in the neighborhood; Neighborhood-traffic-data is generated by combining all the Single-vehicle-traffic-data received from neighboring vehicles; Said Neighborhood-traffic-data is then conditionally propagated to remote area by broadcasting and relaying through one or more participating vehicles, or through other wired/wireless network. Hereby each participating vehicle is able to get updated traffic information of a large area, and able to calculate the optimistic route.

### CROSS REFERENCE TO RELATED APPLICATIONS

This application is Continuation in Part of PPA Application Ser. No. 60/522,026, filed on Aug. 3, 2004.

### BACKGROUND OF INVENTION

1. Technical Field

The present invention relates to a method and apparatus for obtaining and propagating relevant traffic information and dynamically seeking optimized route, and a system to optimize traffic content.

2. Description of Related Art

Currently, traffic information gathering services such as Metro Networks rely on human information sources; e.g., police and fire departments, traffic aircraft, reports phoned in by mobile units, and the like. The information is informed to a driver of a moving object such as a vehicle via broadcast media such as radio. By the time the information gets to a user, it is often too late for the user to take advantage of the information. In many instances the information is no longer valid.

Recently there are some patents depicted new methods for traffic optimization, which involves locating a vehicle using techniques such as GPS or cellular phone network, calculating traffic information such as speed, and make that information available to other vehicles through either central server or distributed request/reply. However, those methods require to identify the vehicle with some means, which will compromise driver's privacy when the driver is using the system; some of them cannot scale up, and some of them require dedicated infrastructure to support.

### OBJECTS AND ADVANTAGES

The object of this invention is to provide a traffic optimization information system that does not require infrastructure to support thus has low cost; does not require to identify the vehicle or the user thus protect privacy; no limit on traffic volume thus robust.

### BRIEF DESCRIPTION OF DRAWINGS

FIG. 1. depicts exchanging of single-vehicle-traffic-data among vehicles.

FIG. 2. depicts distribution of neighborhood-traffic-data to other vehicles in the traffic information system, through broadcast and relay.

### DETAILED DESCRIPTION

A preferred embodiment is explained in detail here. At any time, each participating vehicle may possess the following three levels of traffic data:

1. Single-vehicle-traffic-data: traffic information pertaining to the vehicle itself, such as its current location, current time, and the location at which it was before a predefined time period, such as 3 seconds. The same information can also be expressed as its location, speed, and heading direction.

2. Neighborhood-traffic-data: traffic information pertaining to the local area surrounding the vehicle, within a predefined distance d1, for example 2 miles from the vehicle. This information come from the single-vehicle-traffic-data captured by itself as well as those it received from neighboring vehicles, within a predefined timeframe such as 2 minutes.

3. Wide-area-traffic-data: traffic information pertaining to a large area surrounding the vehicle, within a predefined distance d2, for example 200 miles from the vehicle. This information come from neighborhood-traffic-data distributed by remote vehicles, and is updated continuously with newly received neighborhood-traffic-data.

Single-Vehicle-Traffic-Data

Formation: Each participating vehicle collects it's travel information, such as current location, current time, and the previous location at which it was before a predefined short time period, such as 3 seconds. The same information can also be expressed as its location, moving direction, and speed. The vehicle stores its single-vehicle-traffic-data for a predefined time period, thus at any time it may possess a series of single-vehicle-traffic-data that it captured in that predefined time period.

Exchange: Each participating vehicle broadcast its own single-vehicle-traffic-data either periodically, such as once per 10 seconds, or repeatedly with certain logic. Each participating vehicle receives single-vehicle-traffic-data broadcasted from neighboring vehicles that locates within distance d1 (for example 2 miles). The distance d1 can be derived from the broadcast transmission range. The received single-vehicle-traffic-data is stored for a predefined time period.

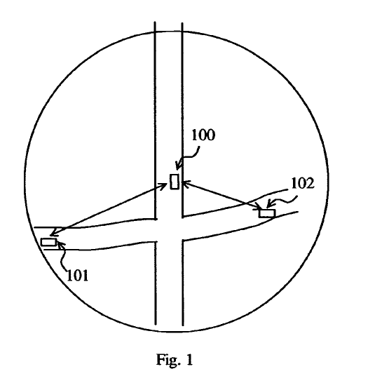

FIG. 1 depicts exchanging of single-vehicle-traffic-data among vehicles. When vehicle 100 broadcast its single-vehicle-traffic-data, vehicles in the transmission range (such as vehicle 101 and 102) receive the data. Similarly, when vehicle 101 or vehicle 102 broadcast their single-vehicle-traffic-data, vehicle 100 can receive the broadcasted data, as vehicle 100 is in the broadcast range of vehicle 101 and that of vehicle 102.

Exchange (variant): If there are multiple vehicles that moves in the same direction at about the same speed on the same lane and locates within a predefined distance d3, it is not necessary for all of the vehicles to broadcast its single-vehicle-traffic-data, as their single-vehicle-traffic-data carry very similar information: the traffic information of the place where all of them locate. The broadcast of any one of them is good enough to input the traffic information of that location/time to the traffic information system. In an embodiment variant, for every time frame with a predefined length, such as 10 seconds, each participating vehicle calculates the difference between it's own single-vehicle-traffic-data collected within current time frame, and those single-vehicle-traffic-data broadcasted within current time frame from neighboring vehicles that moves in the same direction on the same lane and locates within a predefined distance d3; broadcasts it's own single-vehicle-traffic-data only if the calculated difference is bigger than a predefined value. This can avoid broadcasting duplicate information, and the communication volume is not affected by the number of vehicles on the road; instead, for any particular coverage area, the required communication volume has an upper limit.

Summary: The exchange of single-vehicle-traffic-data among vehicles in local area enables that each vehicle knows the traffic situation of its neighborhood area up to distance d1 in all directions. Thus, it is possible for a participating vehicle calculate the traffic speed of its current road, for a short distance ahead of its current location; if the road has multiple lanes, it is possible for the vehicle to know which lane is faster.

Neighborhood-Traffic-Data and Wide-Area-Traffic-Data

Neighborhood-traffic-data Formation: Each participating vehicle contains a series of single-vehicle-traffic-data captured by itself within a predefined timeframe, and also contains lots of single-vehicle-traffic-data that it received from neighboring vehicle within the predefined timeframe. Neighborhood-traffic-data is generated by packaging all these single-vehicle-traffic-data together. The newly generated neighborhood-traffic-data is saved for a predefined time period, and broadcasted conditionally as explained later.

In the preferred embodiment, the formation of neighborhood-traffic-data includes a process to compress or summarize those single-vehicle-traffic-data. This can be done with following steps:
1. match single-vehicle-traffic-data captured or received within current timeframe onto road segment or segments based on road geographical data;
2. for road segments that have two way traffic, classify the single-vehicle-traffic-data matched onto it as two groups based on their heading direction;
3. calculate average traffic speed for each road segment based on single-vehicle-traffic-data matched onto it, for both traffic directions if it has two way traffic;
4. package the road segments, traffic direction, and average speed data; whereby neighborhood-traffic-data is generated.

Road segment can be defined as a part of road separated by road-road interconnecting points, or separated by some logical joint points; in the later case a road segment may contain 0 or multiple road-road interconnecting points. The road geographical data can be pre-stored in the vehicle, or distributed to the vehicle through the traffic information system or other means. The location for logical joint points can be predefined and integrated with road/highway geographical data, or be calculated from the road/highway geographical data with predefined formula, for example, create logical joint points such that the road segments enclosed by them have a predefined length, for example, 100 meters.

Wide-area-traffic-data Formation: Each participating vehicle collects neighborhood-traffic-data distributed from other vehicles in the system, and generates wide-area-traffic-data from them. This can be done as following: by aligning the location data contained in the neighborhood-traffic-data with the road geographical data, and calculate an average traffic speed for each road segment covered by at least one neighborhood-traffic-data.

The wide-area-traffic-data is continuously updated with newly received neighborhood-traffic-data. This can be done with the following steps:
1. for each direction of every road segment covered by said newly received neighborhood-traffic-data, calculate traffic speed value s1 based on the traffic speed value s2 in said newly received neighborhood-traffic-data, and the traffic speed value s3 in said wide-area-traffic-data, with a predefined formula;
2. update the speed value of said direction of said road segment in said wide-area-traffic-data with said traffic speed value s1.

In a preferred embodiment, the predefined formula for calculating traffic speed value s1 is: s1=s2, which means that the speed value in the wide-area-traffic-data is simply replaced by the speed value in the newly received neighborhood-traffic-data for every road segment covered by the newly received neighborhood-traffic-data.

Moreover, in a preferred embodiment, each road segment in wide-area-traffic-data have a field indicating the timeframe of the latest neighborhood-traffic-data covering said road segment. The information contained in this field is useful to determine the freshness of the data for that road segment, and it can be displayed to the user along with the speed information.

Voting and Publish: For every time frame with a predefined length, such as 120 seconds, each participating vehicle compares it's own latest neighborhood-traffic-data with its updated wide-area-traffic-data for the road segments covered by its own latest neighborhood-traffic-data, and calculates a value quantifying the difference, lets call it as NW-Diff. If the NW-Diff is bigger than a predefined value, said own latest neighborhood-traffic-data become “published” neighborhood-traffic-data for the area covered by it, for the current time frame. The “published” neighborhood-traffic-data will be stamped with the information regarding the geographical area and timeframe covered by the data, and then will be distributed to all of the vehicles located within a predefined distance d2, such as 200 miles from the source vehicle, as explained later.

Voting and Publish Dynamics: The result is that every participating vehicle will receive all the latest neighborhood-traffic-data from other areas within the predefined distance d2 (200 miles in this sample), and thus can generate/update their wide-area-traffic-data. With the updated wide-area-traffic-data as well as its own latest neighborhood-traffic-data, the vehicle is able to calculate the up-to-dated traffic information for the surrounding area within the predefined distance d2. Whereby each vehicle can calculate optimized route in real time.

If two vehicles, Vehicle A and Vehicle B, are close to each other such that their neighborhood area overlaps, their neighborhood-traffic-data share some common information. If Vehicle A distributed its latest neighborhood-traffic-data to other vehicles in the system (including Vehicle B); after Vehicle B receive it, Vehicle B's wide-area-traffic-data will be updated with the newly received Vehicle A's neighborhood-traffic-data; Vehicle B's NW-Diff will be reduced, because the neighborhood-traffic-data of the two vehicles carry some duplicated/overlapping information. The closer the two vehicles, the more overlapping information the two vehicles possess, and the more will Vehicle B's NW-Diff be reduced. If the two vehicles are close enough, Vehicle B's NW-Diff may stay under the predefined threshold value. This effectively delays Vehicle B's attempt to distribute its own neighborhood-traffic-data, which overlaps Vehicle A's neighborhood-traffic-data to some extent.

Above example illustrated that for any area, once a vehicle's neighborhood-traffic-data is published and distributed, it prevents vehicles in the nearby from distributing their neighborhood-traffic-data if such neighborhood-traffic-data carries too much overlapping information with the published neighborhood-traffic-data. Thus the published neighborhood-traffic-data is the dominance data for that local area for certain time period.

Distribution: As mentioned earlier, the “published” neighborhood-traffic-data is distributed to almost all of the vehicles located within a predefined distance d2 from the source vehicle. The distribution can be done through broadcast-and-relay by other vehicles in the system, or through other network.

The broadcast-and-relay method for distributing of published neighborhood-traffic-data consists of the following steps:
1. A sender vehicle broadcasts the data; Said sender vehicle is either the source vehicle that published the neighborhood-traffic-data, or one of the relaying vehicles; the current location of the sender vehicle is embedded into the data before it is broadcasted.
2. Each of the participating vehicles within the transmission range of the sender vehicle receives the broadcasted data, called as receiver vehicles; for any receiver vehicle, if none of its stored neighborhood-traffic-data is determined as sharing the same geographical and time-frame coverage with the received data, the receiver vehicle stores the newly received neighborhood-traffic-data and attempts to relay it by re-broadcasting it; rebroadcast is initiated only after a waiting period being passed; the waiting period is calculated based on the distance from the sender vehicle to the receiver vehicle; the longer is the distance, the shorter is the waiting period. The rebroadcast will be stopped if a second neighborhood-traffic-data is received before said waiting period is passed while the second neighborhood-traffic-data is determined sharing the same geographical and time-frame coverage with the to-be-relayed neighborhood-traffic-data.

Waiting period is introduced in broadcast and relay, to ensure that the most far away vehicles get chosen for relaying, thus reduce the number of relaying hops in all the directions.

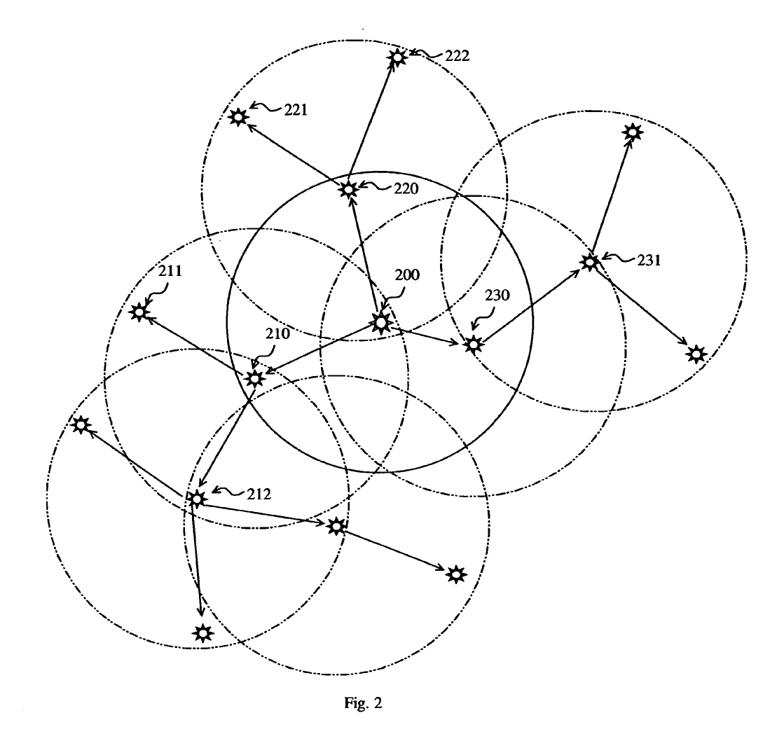

FIG. 2. depicts propagation of neighborhood-traffic-data in the traffic information system through broadcast and relay. When vehicle 200 broadcast its neighborhood-traffic-data, vehicles 210, 220, and 230 receives the broadcast. As this is the first time for vehicle 210, 220, and 230 receive this particular neighborhood-traffic-data, vehicles 210, 220, and 230 try to relay this information by rebroadcast it. When vehicle 210 rebroadcast that neighborhood-traffic-data, vehicle 200, 211, and 212 will receive it; this time vehicle 200 just ignore it, as it already has that data. However, vehicle 211 and 212 will try to further relay it. Similarly, it is relayed in other directions through vehicle 220, 221, 222 and vehicles 230, 231, etc.

Miscellaneous

Pseudo-vehicles: Vehicles may also be pseudo-vehicles or stations that are not necessarily mobile, but at least are equipped with compatible communication means. In addition, pseudo-vehicles or stations may communicate with each other through wired or wireless connections, or, may interface external systems. Each metro area may have one or more stations to collect traffic information from the system, and to distribute information to the system.

Moreover, external data such as road/highway geographical data, digital map, weather information, commercial advertisement, etc. may be distributed to participating vehicles by pseudo-vehicles, in a way similar to that for distribution of published neighborhood-traffic-data. In addition, the data for system maintenance/upgrades, or new value for adjustable parameters in the system, is able to distributed to each vehicle in the same way.

Moreover, all or part of the data flow in the system, such as single-vehicle-traffic-data and neighborhood-traffic-data, can be encrypted when the data is transmitted from one vehicle to another; the encryption will protect the system from fake data inserted by malicious party.

Moreover, the predefined values mentioned in this article can dynamically adjusted based on predefined logic.

In accordance with the invention, an apparatus for determining and optimizing a route of a first vehicle pertaining to a traffic information system to which further vehicles pertain is created, including: display means to display the traffic information to the end user; detection means for detecting vehicle locations; transmitter/receiver means for transmitting/receiving radio signals containing respective traffic information; storage means for storing data; neighborhood-traffic-data generating means for generating neighborhood-traffic-data from available own or alien single-vehicle-traffic-data; wide-area-traffic-data generating means for generating wide-area-traffic-data from alien neighborhood-traffic-data; traffic data evaluation means for comparison of own neighborhood-traffic-data with own wide-area-traffic-data for the area covered by own neighborhood-traffic-data, and for determining whether own neighborhood-traffic-data should be published; means to receive neighborhood-traffic-data; means for determining if and when the received neighborhood-traffic-data need to be relayed; route determining means for determining, with the aid of stored distance data, a route of the first vehicle from its current position up to a selected target; and route optimization means for seeking the best route by driving time/distance etc., based on own wide-area-traffic-data and own neighborhood-traffic-data. Moreover waiting period generation means may be contained for emitting a data signal only after lapse of the determined waiting period; Moreover control means may be contained, whereby emission of the delayed data signal may subsequently be stopped prior to lapse of the waiting period. Moreover data encryption/decryption means may be contained, whereby the data transfer among vehicles is encrypted. By the above described features, and features that are not mentioned above but otherwise being obvious in accordance with the invention, a structure of an intelligent communication device is created.

What is claimed is:

1. A method for exchanging information among at least a first unit pertaining to a group to which further units pertain, comprising the steps performed by the first unit:
(a) collecting data pertaining to itself;
(b) receiving data broadcasted from other units in the group;
(c) calculating a difference value for the difference between said data pertaining to the first unit and those data received from other units; broadcasting said data pertaining to the first unit only if said difference value is bigger than a predefined value.

2. A method for exchanging traffic information among at least a first vehicle pertaining to a traffic information system to which further vehicles pertain, and other vehicles pertaining to said traffic information system, comprising steps performed by said first vehicle:
(a) capturing own single-vehicle-traffic-data, wherein said single-vehicle-traffic-data contains at least the information of current location, current time, and the previous location where said first vehicle was before a predefined time period; broadcasting said own single-vehicle-traffic-data;
(b) receiving alien single-vehicle-traffic-data broadcasted by other vehicles pertaining to said traffic information system and located within a predefined distance;
(c) generating own neighborhood-traffic-data from said own single-vehicle-traffic-data captured within current timeframe with predefined length and said alien single-vehicle-traffic-data received within current timeframe with predefined length;
(d) receiving alien neighborhood-traffic-data generated and distributed by other vehicles pertaining to said traffic information system; generating wide-area-traffic-data by combining said alien neighborhood-traffic-data; updating wide-area-traffic-data with newly received neighborhood-traffic-data;
(e) calculating a difference value between said own neighborhood-traffic-data and said wide-area-traffic-data for the area covered by said own neighborhood-traffic-data; if said difference value is bigger than a predefined value, said own neighborhood-traffic-data is distributed to other vehicles pertaining to said traffic information system.

3. The method as stated in claim 2, wherein said broadcasting said own single-vehicle-traffic-data in step a is conditional to a voting process comprising the following steps performed by said first vehicle:
(a) calculating a difference value between said own single-vehicle-traffic-data and alien single-vehicle-traffic-data broadcasted by other vehicles that have same heading direction with said first vehicle, and located on the line of the heading direction, and within a predefined distance;
(b) said broadcasting is performed only if said calculated difference value is bigger than a predefined value.

4. The method as stated in claim 2, wherein said own neighborhood-traffic-data is distributed to other vehicles pertaining to said traffic information system through broadcasting and relaying by vehicles pertaining to said traffic information system.

5. The method as stated in claim 4, wherein said broadcasting and relaying comprise the following steps:
(a) a sender vehicle broadcasts the data; said first vehicle publishing the data will serve as the first sender vehicle; the current location of the sender vehicle is embedded into the data before it is broadcasted;
(b) a receiver vehicle receives the data broadcasted by said sender vehicle; if said receiver vehicle does not have any neighborhood-traffic-data that is determined sharing the same geographical and time-frame coverage with the received data, the receiver vehicle attempts to relay it by rebroadcast it; said rebroadcast is initiated only after a waiting period being passed; said waiting period is calculated based on the distance between said sender vehicle and said receiver vehicle, a longer distance results in a shorter waiting period; if a second neighborhood-traffic-data is received before said waiting period is passed and said second neighborhood-traffic-data is determined sharing the same geographical and time-frame coverage with the to-be-rebroadcasted neighborhood-traffic-data, said rebroadcast will be stopped;
(c) if said receiver vehicle rebroadcasts the data, said receiver vehicle serves as a sender vehicle; whereby relaying chains are formed.

6. The method as stated in claim 4, wherein said own neighborhood-traffic-data is distributed to other vehicles pertaining to said traffic information system through wired or wireless external network.

7. The method as stated in claim 2, wherein said generating own neighborhood-traffic-data in step c comprise the following steps:
(a) match single-vehicle-traffic-data captured or received within current timeframe onto road segment or segments based on road geographical data;
(b) for road segments that have two way traffic, classify the single-vehicle-traffic-data matched onto it as two groups based on their heading direction;
(c) calculate average traffic speed for each road segment based on single-vehicle-traffic-data associated with it, for both traffic directions if it has two way traffic;
(d) package the road segments, traffic direction, and average speed data; whereby neighborhood-traffic-data is generated.

8. The method as stated in claim 7, wherein said road segment is a part of road separated with logical joint points.

9. The method as stated in claim 8, wherein said logical joint points are predefined and integrated with road geographical data.

10. The method as stated in claim 8, wherein said logical joint points are calculated based on road geographical data, with predefined logic.

11. The method as stated in claim 2, wherein said generating wide-area-traffic-data is performed as following: for every road segment covered by at least one neighborhood-traffic-data, calculate average traffic speed for both directions based on neighborhood-traffic-data; whereby all the road segments and their traffic speed forms the wide-area-traffic-data.

12. The method as stated in claim 2, wherein said updating wide-area-traffic-data with newly received neighborhood-traffic-data comprise the following steps:
(a) for each direction of every road segment covered by said newly received neighborhood-traffic-data, calculate traffic speed value s1 based on the traffic speed value s2 in said newly received neighborhood-traffic-data, and the traffic speed value s3 in said wide-area-traffic-data, with a predefined formula;
(b) update the speed value of said direction of said road segment in said wide-area-traffic-data with said traffic speed value s1.

13. The method as stated in claim 12, wherein said predefined formula for calculating said traffic speed value s1 is: said traffic speed value s1 equals said traffic speed value s2.

14. The method as stated in claim 12, wherein each road segment in wide-area-traffic-data have a field indicating the timeframe of the last received neighborhood-traffic-data covering said road segment.

15. The method as stated in claim 2,wherein said single-vehicle-traffic-data contains at least the information of current location, current time, speed, and heading direction of said first vehicle.

16. A method for optimizing traffic routing of at least a first vehicle pertaining to at least a traffic information system to which further vehicles pertain, comprising the steps performed by the first vehicle:
(a) obtaining traffic information pertaining to itself, including at least the information to calculate the current location, the current time, and the previous location before a predefined time period;
(b) exchanging said information with other vehicles in the traffic information system; whereby said first vehicle have the traffic information pertaining to other vehicles in the traffic information system; whereby said first vehicle can calculate traffic information pertaining to its potential routes.
